(19) United States
(12) Patent Application Publication
(10) Pub. No.: US 2026/0302281 A1
(43) Pub. Date: Oct. 1, 2026

(54) GAS-LIQUID SEPARATION DEVICE AND FUEL CELL SYSTEM

(71) Applicant: HONDA MOTOR CO., LTD., TOKYO (JP)

(72) Inventors: Shota MAEDA, WAKO-SHI (JP); Yuji OKAMURA, WAKO-SHI (JP)

(21) Appl. No.: 19/576,764

(22) Filed: Mar. 24, 2026

(30) Foreign Application Priority Data
Mar. 27, 2025 (JP) 2025-054236

(51) Int. Cl. H01M 8/04119; H01M 8/04007; H01M 8/04223; H01M 8/04828; H01M 8/0662

(52) U.S. Cl. CPC H01M 8/04164; H01M 8/04037; H01M 8/04253; H01M 8/04843; H01M 8/0662

(57) ABSTRACT

A gas-liquid separation device includes: a gas-liquid separation unit that separates exhaust gas discharged from a fuel cell into gas and liquid; a reservoir unit that can store liquidseparated by the gas-liquid separation unit; a drain valve provided at a lower end portion of the reservoir unit; and a heater provided in the reservoir unit, wherein a heat generating portion of the heater includes an internal heat generating portion located inside the reservoir unit, and the internal heat generating portion and a drain inlet of the drain valve face each other.

### CROSS-REFERENCE TO RELATED APPLICATIONS

This application is based upon and claims the benefit of priority from Japanese Patent Application No. 2025-054236 filed on Mar. 27, 2025, the contents of which are incorporated herein by reference.

### BACKGROUND OF THE INVENTION

### Field of the Invention

The present disclosure relates to a gas-liquid separation device and a fuel cell system.

### Description of the Related Art

In recent years, research and development have been conducted on fuel cell systems that contribute to energy efficiency in order to ensure that more people have access to affordable, reliable, sustainable and modern energy.

JP 2020-187841 A discloses a fuel cell system including a gas-liquid separation device that separates exhaust gas discharged from a fuel cell stack (fuel cell) into gas and liquid.

### SUMMARY OF THE INVENTION

There has been a demand for a more satisfactory gas-liquid separation device and a more satisfactory fuel cell system.

The present disclosure has the object of solving the above-described problem.

A first aspect of the present disclosure is characterized by a gas-liquid separation devicecomprising: a gas-liquid separation unit configured to separate exhaust gas discharged from a fuel cell into gas and liquid;a reservoir unit configured to store liquidseparated by the gas-liquid separation unit;a drain valve provided at a lower end portion of the reservoir unit; anda heater provided in the reservoir unit,whereinthe heater includes a heat generating portion, and the heat generating portion includes an internal heat generating portion located inside the reservoir unit, andthe internal heat generating portion and a drain inlet of the drain valve face each other.

A second aspect of the present disclosure is characterized by a fuel cell system comprising: a fuel cell; and the gas-liquid separation device described above.

According to the present disclosure, it is possible to provide a more satisfactory gas-liquid separation device and a more satisfactory fuel cell system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a fuel cell system;

FIG. 2 is a partially omitted cross-sectional view of a gas-liquid separation device;

FIG. 3 is a partially omitted cross-sectional view taken along line III-III of FIG. 2;

FIG. 4 is a cross-sectional explanatory view showing a state in which ice inside a reservoir unit is melted by a heater; and

FIG. 5 is a cross-sectional explanatory view showing a state in which ice inside the reservoir unit is melted by the heater.

### DETAILED DESCRIPTION OF THE INVENTION

In a fuel cell system, a fuel cell generates water as it generates electric power. Therefore, the exhaust gas discharged from the fuel cell contains moisture. The exhaust gas is separated into gas and liquid by a gas-liquid separation unit of the gas-liquid separation device. The liquid water obtained by the gas-liquid separation by the gas-liquid separation unit is stored in the reservoir unit. A drain valve for discharging the liquid water stored in the reservoir unit is provided at a lower end portion of the reservoir unit.

After the power generation of the fuel cell is stopped (after the operation of the fuel cell is stopped), the moisture contained in the exhaust gas may be accumulated as residual water inside the reservoir unit. After the power generation of the fuel cell is stopped, the temperature of the exhaust gas is lower than that during the power generation, and therefore, the water vapor contained in the exhaust gas is likely to condense and remain inside the reservoir unit. When the liquid water remaining inside the reservoir unit is frozen, communication between the drain inlet of the drain valve and the internal space of the gas-liquid separation unit may be blocked. In this case, there is a concern that the fuel cell system cannot be smoothly started. According to the following disclosure, communication between the internal space of the gas-liquid separation unit and the drain inlet can be quickly established by melting ice inside the reservoir unit.

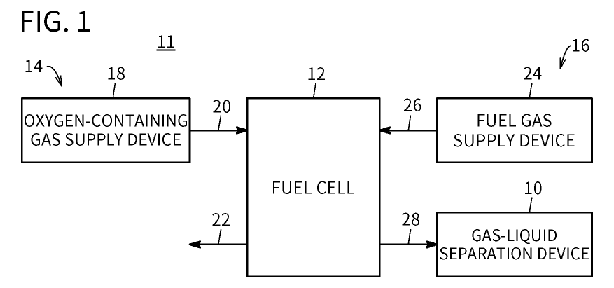

A gas-liquid separation device 10 and a fuel cell system 11 according to an embodiment of the present disclosure will be described below with reference to the drawings. FIG. 1 is a schematic diagram of the fuel cell system 11.

The fuel cell system 11 shown in FIG. 1 is mounted in, for example, a fuel cell vehicle (not shown). Note that the fuel cell system 11 may be mounted in a device other than a vehicle. The fuel cell system 11 may be used as a stationary power source.

As shown in FIG. 1, the fuel cell system 11 includes a fuel cell 12, an oxygen-containing gas-related device 14, and a fuel gas-related device 16. The fuel cell 12 includes a power generation cell (not shown). The power generation cell generates electric power by an electrochemical reaction between an oxygen-containing gas (for example, air) and a fuel gas (for example, hydrogen gas). In the present embodiment, the fuel cell 12 is a fuel cell stack formed by stacking a plurality of power generation cells. The fuel cell 12 may be formed by a single power generation cell.

The oxygen-containing gas-related device 14 includes an oxygen-containing gas supply device 18, an oxygen-containing gas supply path 20, and an oxygen-containing gas discharge path 22. Although other constituent elements may be provided in the oxygen-containing gas-related device 14 apart from these constituent elements, description of such elements will be omitted herein.

The oxygen-containing gas supply device 18 may include, for example, a pump that feeds the oxygen-containing gas, various on-off valves, and the like. The oxygen-containing gas supply path 20 connects the oxygen-containing gas supply device 18 and the fuel cell 12. The oxygen-containing gas supply path 20 is configured to supply the oxygen-containing gas fed from the oxygen-containing gas supply device 18, to the fuel cell 12. An oxygen-containing exhaust gas (oxygen-containing off-gas) discharged from the fuel cell 12 flows through the oxygen-containing gas discharge path 22.

The fuel gas-related device 16 includes a fuel gas supply device 24, a fuel gas supply path 26, a fuel gas discharge path 28, and a gas-liquid separation device 10. Although other constituent elements may be provided in the fuel gas-related device 16 apart from these constituent elements, description of such elements will be omitted herein.

The fuel gas supply device 24 may include, for example, a fuel gas tank, an injector, an ejector, various on-off valves, and the like. The fuel gas supply path 26 connects the fuel gas supply device 24 and the fuel cell 12. The fuel gas supply path 26 is configured to supply the fuel gas guided from the fuel gas supply device 24, to the fuel cell 12.

The fuel gas discharge path 28 connects the fuel cell 12 and the gas-liquid separation device 10. A fuel exhaust gas (fuel off-gas) discharged from the fuel cell 12 flows through the fuel gas discharge path 28. Hereinafter, the fuel exhaust gas that is discharged from the fuel cell 12 and guided to the gas-liquid separation device 10 may be simply referred to as "exhaust gas". The exhaust gas contains moisture generated by the power generation of the fuel cell 12.

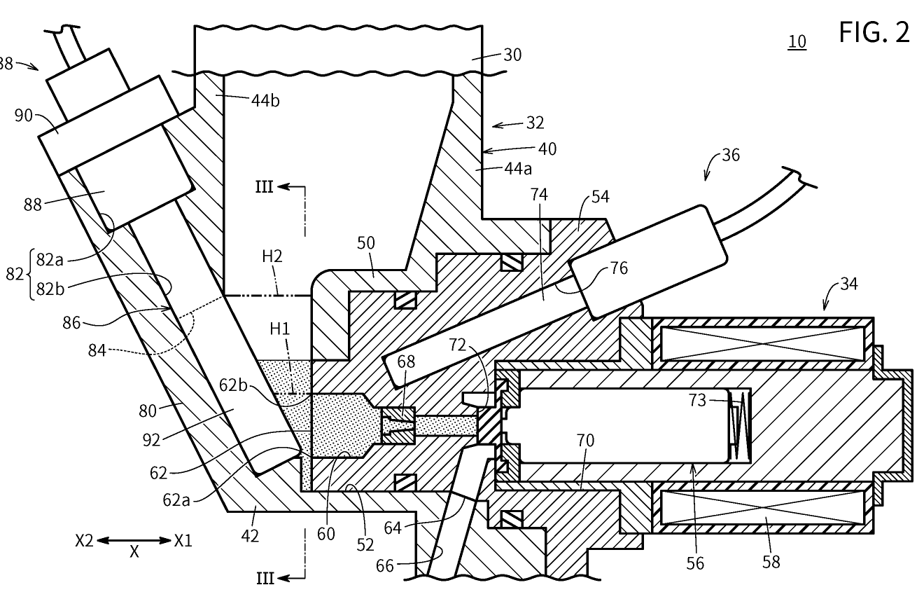

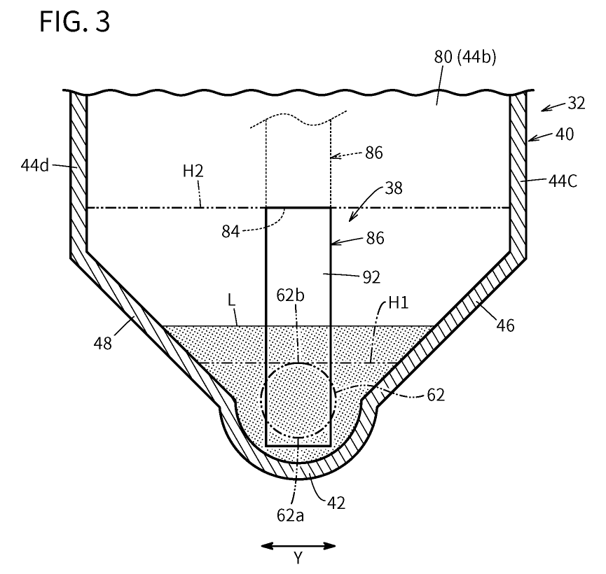

FIG. 2 is a partially omitted cross-sectional view of the gas-liquid separation device 10. FIG. 3 is a partially omitted cross-sectional view taken along line III-III of FIG. 2. As shown in FIGS. 2 and 3, the gas-liquid separation device 10 includes a gas-liquid separation unit 30, a reservoir unit 32, a drain valve 34, a valve heater 36, and a heater 38.

The fuel gas discharge path 28 (see FIG. 1) is connected to the gas-liquid separation unit 30. The gas-liquid separation unit 30 separates the exhaust gas discharged from the fuel cell 12 into gas and liquid. The reservoir unit 32 can store the liquid water obtained by the gas-liquid separation by the gas-liquid separation unit 30. The reservoir unit 32 is provided below the gas-liquid separation unit 30.

The reservoir unit 32 includes a peripheral wall portion 40 and a bottom wall portion 42. The peripheral wall portion 40 is formed in a quadrangular tubular shape, for example. The shape, size, and the like of the peripheral wall portion 40 can be set as appropriate. The peripheral wall portion 40 includes, for example, a first side wall portion 44a, a second side wall portion 44b, a third side wall portion 44c, and a fourth side wall portion 44d.

The first side wall portion 44a and the second side wall portion 44b face each other in an X direction (see FIG. 2). As shown in FIG. 3, the third side wall portion 44c and the fourth side wall portion 44d face each other in a Y direction. The reservoir unit 32 is formed such that the storage cross-sectional area thereof decreases downward. This enables the liquid water stored inside the reservoir unit 32 to be smoothly guided to a drain inlet 62 of the drain valve 34.

Specifically, the third side wall portion 44c includes an inclined portion 46 that is inclined downward toward the fourth side wall portion 44d. A lower end portion of the inclined portion 46 is connected to the bottom wall portion 42. The fourth side wall portion 44d includes an inclined portion 48 that is inclined downward toward the third side wall portion 44c. A lower end portion of the inclined portion 48 is connected to the bottom wall portion 42. The bottom wall portion 42 has an arc-shaped cross-sectional shape when viewed from the X direction.

As shown in FIG. 2, the drain valve 34 is provided at a lower end portion of the reservoir unit 32. The drain valve 34 is a valve for discharging the liquid water stored in the reservoir unit 32 to the outside. The drain valve 34 is attached to a valve attachment portion 50 provided at a lower end portion of the first side wall portion 44a. The valve attachment portion 50 protrudes from the lower end portion of the first side wall portion 44a toward the second side wall portion 44b (in an X2 direction). A valve attachment hole 52 into which the drain valve 34 is inserted is formed in the valve attachment portion 50.

The drain valve 34 is, for example, an electromagnetic valve (solenoid valve). The drain valve 34 includes a housing 54, a solenoid portion 56, and a valve portion 58. A flow path 60 through which liquid water can flow is formed in the housing 54. The flow path 60 includes the drain inlet 62 and a drain outlet 64. The drain inlet 62 is open toward the inside of the reservoir unit 32. The drain inlet 62 is oriented in a direction lying along the horizontal direction. The drain inlet 62 faces the second side wall portion 44b (is orientedin theX2 direction).

The drain outlet 64 is open toward a drain flow path 66 provided in the valve attachment portion 50. The flow path 60 is provided with an orifice 68. The orifice 68 is a portion of the flow path 60 where the cross-sectional area (diameter) is the smallest. That is, in an environment below the freezing point (low-temperature environment), the liquid water is likely to freeze at the orifice 68.

The valve portion 58 is movable forward and backward in a valve chamber 70 formed in the housing 54. The flow path 60 is closed by the valve portion 58 being seated on a valve seat 72 formed in the housing 54. The valve portion 58 is biased toward the valve seat 72 by a biasing member 73. The valve portion 58 is displaced in a direction away from the valve seat 72 by an electromagnetic force generated by supplying electric power to the solenoid portion 56. The flow path 60 is opened by the valve portion 58 moving away from the valve seat 72.

The valve heater 36 is provided in the housing 54 of the drain valve 34. The valve heater 36 includes a valve heat generatingportion 74 which generates heat by being supplied with electric power. The valve heat generatingportion 74 is formed in a rod shape. The valve heat generatingportion 74 is inserted into a hole portion 76 formed in the housing 54. A distal end of the valve heat generatingportion 74 is located close to the orifice 68. In this case, the heat generated by the valve heat generatingportion 74 can be efficiently transferred to the orifice 68. Therefore, the ice frozen at the orifice 68 can be quickly melted.

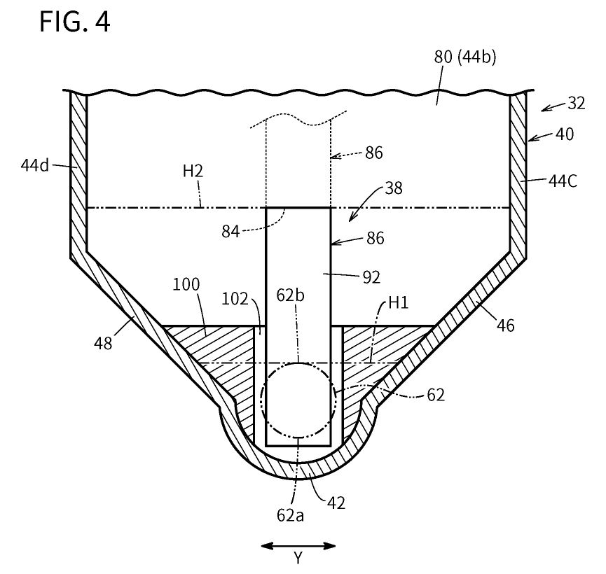

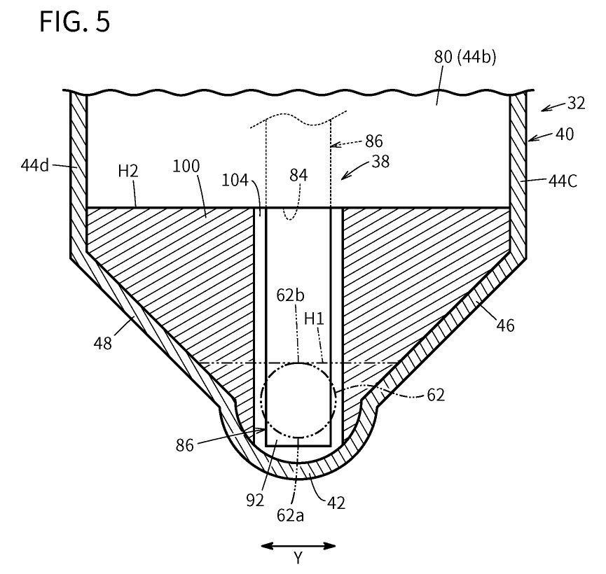

The heater 38 is provided in the reservoir unit 32. In the case where the liquid water remaining inside the reservoir unit 32 is frozen, ice 100 inside the reservoir unit 32 can be melted (see FIGS. 4 and 5). The heater 38 is attached to a heater attachment portion 80 provided at a lower end portion of the second side wall portion 44b. A heater attachment hole 82 into which the heater 38 is inserted is formed in the heater attachment portion 80.

The heater attachment hole 82 extends so as to be inclined downward in the X1 direction. The heater attachment hole 82 includes a first hole portion 82a and a second hole portion 82b. The first hole portion 82a is open to an outer surface of the second side wall portion 44b. The second hole portion 82b is open to a bottom surface of the first hole portion 82a and an inner surface of the second side wall portion 44b. The second hole portion 82b has a smaller diameter than the first hole portion 82a. That is, an opening 84 communicating with the second hole portion 82b is formed in the inner surface of the second side wall portion 44b. The opening 84 is located above an upper end 62b of the drain inlet 62.

The heater 38 includes a heat generating portion 86, a heater support portion 88, and an attachment flange (a heater holding portion) 90. The heat generating portion 86 generates heat by being supplied with electric power. The heat generating portion 86 is formed in a rod shape. As a result, the configuration of the heat generating portion 86 can be simplified. Note that the heat generating portion 86 may not be formed in a rod shape. The heat generating portion 86 is inserted through the first hole portion 82a. The heat generating portion 86 includes an internal heat generating portion 92 located inside the reservoir unit 32. That is, the internal heat generating portion 92 is a portion of the heat generating portion 86 that is located inside the reservoir unit 32.

The heater 38 is attached to the second side wall portion 44b, which is a side wall portion of the reservoir unit 32 that is located in the opening direction (the X2 direction) with respect to the drain inlet 62. As a result, a gap through which the liquid water flows can be easily provided between the internal heat generating portion 92 and the drain inlet 62, and therefore, the liquid water stored inside the reservoir unit 32 can be made to smoothly flow to the drain inlet 62. That is, it is possible to suppress a situation in which the internal heat generating portion 92 hinders the flow of the liquid water.

The internal heat generating portion 92 is inclined downward in a direction (the X1 direction) opposite to the opening direction (the X2 direction) of the drain inlet 62. This allows water in contact with the internal heat generating portion 92 to flow to the drain inlet 62 along the internal heat generating portion 92.

The internal heat generating portion 92 and the drain inlet 62 of the drain valve 34 face each other. When viewed from the opening direction of the drain inlet 62 (the X direction), the internal heat generating portion 92 overlaps the drain inlet 62 over the entire length thereof in the height direction of the drain inlet 62 (see FIG. 3). As a result, the ice 100 around the drain inlet 62 can be efficiently melted by the internal heat generating portion 92 (see FIGS. 4 and 5).

A distal end portion of the internal heat generating portion 92 is located close to a lower end 62a of the drain inlet 62. As a result, the ice 100 around the drain inlet 62 can be melted more efficiently by the internal heat generating portion 92 (see FIGS. 4 and 5). An upper end portion of the internal heat generating portion 92 is located above the upper end 62b of the drain inlet 62. As a result, the ice 100 located above the drain inlet 62 can be efficiently melted by the internal heat generating portion 92 (see FIG. 5).

The heater support portion 88 supports the heat generating portion 86. The heater support portion 88 is disposed in the first hole portion 82a. The attachment flange 90 is fixed to the heater support portion 88. The attachment flange 90 is fixed to the second side wall portion 44b by bolts (not shown).

In the case where a liquid level L of the residual water inside the reservoir unit 32 is located above a height position H1 of the upper end 62b of the drain inlet 62 after the power generation of the fuel cell 12 is stopped (after the operation thereof is stopped), if the residual water is frozen, the communication between the internal space of the gas-liquid separation unit 30 and the drain inlet 62 of the drain valve 34 may be blocked by the ice 100.

In the case where the fuel cell system 11 is started in such a situation, electric power is supplied to the valve heater 36 and the heater 38. When electric power is supplied to the valve heater 36, the valve heat generating portion 74 generates heat. This makes it possible to quickly melt the ice in the flow path 60 of the drain valve 34.

Further, when electric power is supplied to the heater 38, the heat generating portion 86 of the heater 38 generates heat. This makes it possible to quickly melt the ice 100 around the internal heat generating portion 92. FIG. 4 is a cross-sectional explanatory view showing a state in which the ice 100 inside the reservoir unit 32 is melted by the heater 38. In the present embodiment, as shown in FIG. 4, even in a state where the ice 100 inside the reservoir unit 32 is not entirely melted, an open channel 102 that allows the internal space of the gas-liquid separation unit 30 and the drain inlet 62 to communicate with each other can be formed in the ice 100by the ice 100 around the internal heat generating portion 92 being melted. As a result, the ice 100 inside the reservoir unit 32 can be quickly melted to allow communication between the internal space of the gas-liquid separation unit 30 and the drain inlet 62.

FIG. 5 is a cross-sectional explanatory view showing a state in which the ice 100 inside the reservoir unit 32 is melted by the heater 38. Further, in the present embodiment, for example, as shown in FIG. 5, in the case where the residual water is frozen in a state where the liquid level L of the residual water inside the reservoir unit 32 is located at a height position H2 of the upper end of the internal heat generating portion 92, the open channel 104 that allows the internal space of the gas-liquid separation unit 30 and the drain inlet 62 to communicate with each other can be formed in the ice 100 as long as the ice 100 around the internal heat generating portion 92 is melted even in a state where the ice 100 inside the reservoir unit 32 is not entirely melted. As a result, the ice 100 inside the reservoir unit 32 can be quickly melted to allow communication between the internal space of the gas-liquid separation unit 30 and the drain inlet 62.

The volume of the ice 100 inside the reservoir unit 32 shown in FIG. 5 is larger than the volume of the ice 100 inside the reservoir unit 32 shown in FIG. 4. However, the time from when the supply of electric power to the heater 38 is started to when communication between the internal space of the gas-liquid separation unit 30 and the drain inlet 62 is established in FIG. 5 is substantially the same as the time from when the supply of electric power to the heater 38 is started to when communication between the internal space of the gas-liquid separation unit 30 and the drain inlet 62 is established in FIG. 4. That is, in the present embodiment, when the liquid level L of the residual water inside the reservoir unit 32 is equal to or lower than the height position H2, the time from when the supply of electric power to the heater 38 is started to when communication between the internal space of the gas-liquid separation unit 30 and the drain inlet 62 is established can be made substantially constant.

According to the present embodiment, the heat generating portion 86 of the heater 38 includes the internal heat generating portion 92 located inside the reservoir unit 32. The internal heat generating portion 92 and the drain inlet 62 of the drain valve 34 face each other. Therefore, even in the case where the residual water inside the reservoir unit 32 is frozen when the fuel cell 12 is started and the communication between the internal space of the gas-liquid separation unit 30 and the drain inlet 62 is blocked, the ice 100 around the drain inlet 62 can be melted by the internal heat generating portion 92. As a result, communication between the internal space of the gas-liquid separation unit 30 and the drain inlet 62 can be quickly established. Therefore, the more satisfactory gas-liquid separation device 10 and the more satisfactory fuel cell system 11 can be obtained.

The present embodiment is not limited to the configuration described above. Fins, protrusions, or the like may be provided on the outer peripheral surface of the internal heat generating portion 92. In this case, the surface area of the internal heat generating portion 92 can be increased with a simple configuration. The heater 38 may be provided on any of the third side wall portion 44c, the fourth side wall portion 44d, and the bottom wall portion 42. Even in such a case, the internal heat generating portion 92 and the drain inlet 62 face each other. In the case where the heater 38 is provided on the third side wall portion 44c or the fourth side wall portion 44d, the heat generating portion 86 may extend along the Y direction. In the case where the heater 38 is provided on the bottom wall portion 42, the heat generating portion 86 may extend along the up-down direction so as to penetrate the bottom wall portion 42. The gas-liquid separation device 10 may not be provided with the valve heater 36. Even in such a case, the ice in the flow path 60 of the drain valve 34 can be melted by the heat of the internal heat generating portion 92.

The following supplementary notes are further disclosed in relation to the above-described embodiment.

### Supplementary Note 1

The gas-liquid separation device (10) of the present disclosure includes: the gas-liquid separation unit (30) configured to separate exhaust gas discharged from the fuel cell (12) into gas and liquid; the reservoir unit (32) configured to store liquidseparated by the gas-liquid separation unit; the drain valve (34) provided at the lower end portion of the reservoir unit; and the heater (38) provided in the reservoir unit, wherein the heat generating portion (86) of the heater includes the internal heat generating portion (92) located inside the reservoir unit, and the internal heat generating portion and the drain inlet (62) of the drain valve face each other.

According to such a configuration, even in the case where the residual water inside the reservoir unit is frozen when the fuel cell is started and the communication between the internal space of the gas-liquid separation unit and the drain inlet is blocked, the ice around the drain inlet can be melted by the internal heat generating portion. As a result, communication between the internal space of the gas-liquid separation unit and the drain inlet can be quickly established. Therefore, a more satisfactory gas-liquid separation device can be obtained.

### Supplementary Note 2

In the gas-liquid separation device according to Supplementary Note 1, the drain inlet may be oriented in a direction lying along the horizontal direction, and the internal heat generating portion may overlap the drain inlet over the entire length thereof in the height direction of the drain inlet when viewed from the opening direction of the drain inlet.

According to such a configuration, the ice around the drain inlet can be efficiently melted by the internal heat generating portion.

### Supplementary Note 3

In the gas-liquid separation device according to Supplementary Note 2, the upper end portion of the internal heat generating portion may be located above the upper end (62b) of the drain inlet.

According to such a configuration, the ice located above the drain inlet can be efficiently melted by the internal heat generating portion.

### Supplementary Note 4

In the gas-liquid separation device according to Supplementary Note 2 or 3, the heat generating portion may be formed in a rod shape.

According to such a configuration, the configuration of the heat generating portion can be simplified.

### Supplementary Note 5

In the gas-liquid separation device according to Supplementary Note 4, the heater may be attached to the side wall portion (44b) of the reservoir unit that is located in the opening direction with respect to the drain inlet.

According to such a configuration, a gap through which the liquid water flows can be easily provided between the internal heat generating portion and the drain inlet, and therefore, the liquid water stored inside the reservoir unit can be made to smoothly flow to the drain inlet. That is, it is possible to suppress a situation in which the internal heat generating portion hinders the flow of the liquid water.

### Supplementary Note 6

In the gas-liquid separation device according to Supplementary Note 5, the internal heat generating portion may be inclined downward in a direction opposite to the opening direction.

According to such a configuration, the water in contact with the internal heat generating portion can be made to flow to the drain inlet along the internal heat generating portion.

### Supplementary Note 7

In the gas-liquid separation device according to Supplementary Note 6, the distal end portion of the internal heat generating portion may be located close to the lower end (62a) of the drain inlet.

According to such a configuration, the ice around the drain inlet can be melted more efficiently by the internal heat generating portion.

### Supplementary Note 8

In the gas-liquid separation device according to any one of Supplementary Notes 1 to 7, the reservoir unit may be formed in a manner so that the storage cross-sectional area thereof decreases downward.

According to such a configuration, the liquid water stored inside the reservoir unit can be smoothly guided to the drain inlet.

### Supplementary Note 9

The fuel cell system (11) of the present disclosure includes the fuel cell, and the gas-liquid separation device according to any one of Supplementary Notes 1 to 8

According to such a configuration, it is possible to obtain the fuel cell system that achieves the effects of the gas-liquid separation device according to any one of Supplementary Notes 1 to 8. Therefore, a more satisfactory fuel cell system can be obtained.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A gas-liquid separation device comprising:
a gas-liquid separation unit configured to separate exhaust gas discharged from a fuel cell into gas and liquid;
a reservoir unit configured to store liquidseparated by the gas-liquid separation unit;
a drain valve provided at a lower end portion of the reservoir unit; and
a heater provided in the reservoir unit,
whereinthe heater includes a heat generating portion, and the heat generating portion includes an internal heat generating portion located inside the reservoir unit, and
the internal heat generating portion and a drain inlet of the drain valve face each other.

2. The gas-liquid separation device according to claim 1, wherein
the drain inlet is oriented in a direction lying along a horizontal direction, and
the internal heat generating portion overlaps the drain inlet over an entire length of the drain inlet in a height direction of the drain inlet when viewed from an opening direction of the drain inlet.

3. The gas-liquid separation device according to claim 2, wherein
an upper end portion of the internal heat generating portion is located above an upper end of the drain inlet.

4. The gas-liquid separation device according to claim 2, wherein
the heat generating portion is formed in a rod shape.

5. The gas-liquid separation device according to claim 4, wherein
the heater is attached to a side wall portion of the reservoir unit that is located in the opening direction with respect to the drain inlet.

6. The gas-liquid separation device according to claim 5, wherein
the internal heat generating portion is inclined downward in a direction opposite to the opening direction.

7. The gas-liquid separation device according to claim 6, wherein
a distal end portion of the internal heat generating portion is located close to a lower end of the drain inlet.

8. The gas-liquid separation device according to claim 1, wherein
the reservoir unit is formed in a manner so that a storage cross-sectional area of the reservoir unit decreases downward.

9. A fuel cell system comprising:
a fuel cell; and
the gas-liquid separation device according to claim 1.
